(19) United States
(12) Patent Application Publication
(10) Pub. No.: US 2026/0311982 A1
(43) Pub. Date: Oct. 8, 2026

(54) MASS SPECTROMETRY

(71) Applicant: Thermo Fisher Scientific (Bremen) GmbH, Bremen (DE)

(72) Inventors: Adrian Schütz, Hofgeismar (DE); Oliver Lange, Bremen (DE); Daniel Marc Mourad, Bremen (DE)

(21) Appl. No.: 19/640,270

(22) Filed: Apr. 6, 2026

(30) Foreign Application Priority Data
Apr. 4, 2025 (GB) GB2505111.1

(51) Int. Cl. H01J 49/00

(52) U.S. Cl. CPC H01J 49/0036

(57) ABSTRACT

There is provided a method of generating a stitched mass spectrum in Fourier transform mass spectrometry. The method comprises: obtaining a transient recorded from ions stored within a mass spectrometer; performing a first Fourier transform of at least a first portion of the transient at a first resolution to obtain a first mass spectrum; performing a second Fourier transform of at least a second portion of the transient at a second resolution to obtain a second mass spectrum, wherein the second resolution is lower than the first resolution; comparing a peak size of a candidate peak in the first mass spectrum against a threshold; responsive to determining that the peak size of the candidate peak of the first mass spectrum is less than the threshold, replacing the candidate peak in the first mass spectrum with the corresponding peak in the second mass spectrum, thereby producing a stitched mass spectrum.

### FIELD

The invention relates to Fourier transform mass spectrometry.

### BACKGROUND

As described in our US Patent No, 10,755,907, Fourier transform mass spectrometry often sees an analyte of interest undergo a separation step using established chromatographic techniques such as liquid or gas chromatography. This separation helps to reduce the complexity of the analyte sample. Subsequently, the analyte is ionized using established ionization techniques like matrix-assisted laser desorption/ionization (MALDI), electron ionization and atmospheric ionization including electrospray ionization (ESI), and the ions are directed into the Fourier transform mass spectrometer with ion optics. The ions may undergo further steps including isolation and/or fragmentation. Once inside the ion detector of the Fourier transform mass spectrometer, the ions may be trapped using an electric field, as in the case of the Orbitrap (TM) mass analyzer, or a combination of electric and magnetic fields, as in a Fourier transform ion cyclotron resonance mass spectrometer. Once trapped, resonant oscillations are induced in the ions. These oscillating ions generate a charge, known as the image charge, on the detector plates of the mass spectrometer. The resulting image current is measured by collecting a signal from the detector plates which is then amplified by a preamplifier, digitized, and recorded in the form of a transient. Generally, many transients are collected and processed together to derive a mass spectrum.

The transients are converted into frequency space by means of Fourier transform. This conversion from the time-domain to the frequency-domain allows for a measurement of the underlying harmonic frequency components, which are unambiguously connected to the mass-to-charge-ratio of the ions in the mass spectrometer. The obtained frequencies and amplitudes serve as input data for further analysis of the input sample composition.

In Fourier transform mass spectrometry, the length of the transient signal is proportional to the spectral peak resolution due to the nature of Fourier transform. Hence, the ability to resolve harmonic components from a discrete spectrum depends on the recording time of the transient. For a given sample frequency, a longer recording time (and therefore larger transient length) leads to a better resolution. Just scaling up the recording time is usually not a feasible solution to this problem, however, as non-harmonic effects like signal decay then come into play.

Interference between peaks can arise when two ions produce spectral peaks that are very close together (due to closeness in m/z values). For certain resolutions, the peaks can be only partially resolved by the Fourier transform: a transient sufficiently longer would enable full resolution and a transient sufficiently shorter would see the peaks fully merged. The interference arising from partial resolution can be destructive which leads to diminished signals and an underreporting of the abundance of those two ions. The interference occurs when the proximity of the two mass-to-charge values in frequency space results in peaks that partially overlap. This partial overlap makes it challenging to distinguish and resolve the individual peaks accurately. This is especially prevalent in larger multiply charged molecules due to their isotopes being close in m/z and therefore hard to resolve sufficiently to avoid interference effects.

However, interference between overlapping peaks of ions with close m/z values can be avoided by using a higher resolution but this requires longer scan times to record the longer transient. Another approach is to use a lower resolution which has the advantage of decreasing the scan time. Lowering the resolution leads to the partially-resolved peaks gradually merging into a single peak such that the interference effects do not arise. Hence, a known method of avoiding issues with peak interference is to take further scans with reduced scan times, and hence reduced transients and resolution. However, the need for multiple measurements at different resolutions is detrimental as it leads to an overall increase in data collection time, thereby decreasing throughput. This technique also leads to a sub-optimal use of the informational content of the limited sample at hand.

### SUMMARY

According to a first aspect, the present invention resides in a method of generating a stitched mass spectrum in Fourier transform mass spectrometry. The method comprises obtaining a transient recorded from ions stored within a mass spectrometer, performing a first Fourier transform of at least a first portion of the transient at a first resolution to obtain a first mass spectrum, and performing a second Fourier transform of at least a second portion of the transient at a second resolution to obtain a second mass spectrum. The second resolution is lower than the first resolution. The method further comprises comparing a peak size of a candidate peak in the first mass spectrum against a threshold. Responsive to determining that the peak size of the candidate peak of the first mass spectrum is less than the threshold, the candidate peak in the first mass spectrum is replaced with the corresponding peak in the second mass spectrum, thereby producing a stitched mass spectrum.

This method avoids having to make repeated measurements of a sample at different resolutions. Instead, a single transient recorded at a certain resolution is used as the basis for creating a relatively high-resolution mass spectrum and a relatively low-resolution mass spectrum. These spectra are obtained using windows of the transient having different lengths. The high-resolution and low-resolution mass spectra are combined to produce a stitched mass spectrum in a way that removes the peaks in the high-resolution mass spectrum that are suppressed through interference. Avoiding additional measurements provides time savings that are a critical improvement in liquid chromatography (LC) applications which are extremely time sensitive.

To ensure consistent results and/or ease of setting a reliable value for the threshold, the method may further comprise normalizing the first mass spectrum prior to comparing the peak size of the candidate peak in the first mass spectrum against the threshold. The first mass spectrum may be normalised by scaling the peak intensities relative to the intensity of the largest peak in the first mass spectrum. For example, the value of each data point in the first mass spectrum may be divided by the intensity of the largest peak such that the maximum value is one. The threshold may have a constant value, i.e. the candidate peak is compared to the same threshold value irrespective of the candidate peak’s position on the m/z scale of the first mass spectrum. Alternatively, the value of the threshold may vary as a function of the m/z values in the first mass spectrum. For example, the threshold may decrease in value as the m/z values increase.

In currently preferred embodiments, a relative threshold is employed that uses the size of the candidate peak in the first mass spectrum relative to the size of the corresponding peak in the second mass spectrum as a way of determining whether the candidate peak in the first mass spectrum is suppressed due to peak interference. To this end, the method may further comprise normalizing the first and second mass spectra prior to comparing the peak size of the candidate peak in the first mass spectrum against the threshold. The first and second mass spectra may be normalised by scaling the peak intensities relative to the intensity of the largest peak in the respective spectrum. For example, the value of each data point in the first mass spectrum may be divided by the intensity of the largest peak in that spectrum such that the maximum value is one, and the value of each data point in the second mass spectrum may be divided by the intensity of the largest peak in the first spectrum. The method may then comprise determining the peak size of the candidate peak in the first mass spectrum relative to the corresponding peak size of the corresponding peak in the second mass spectrum to obtain a relative peak size of the candidate peak in the first mass spectrum. Then, comparing the peak size of the candidate peak in the first mass spectrum against the threshold comprises comparing the relative peak size to the threshold. In this way, the peak intensities of the low resolution (second) mass spectrum are used as a reference level. This level is then compared peak by peak against the high resolution (first) mass spectrum. A benefit of using the relative comparison is that is takes the abundance of the analyte in the sample into account by normalizing the intensities, which would not be the case for the absolute thresholds discussed above. However, using a constant threshold keeps the number of degrees of freedom as small as possible, and so different types of thresholds may be better for different circumstances.

Setting the value of the threshold may be performed manually or automatically. Also, the method may comprise varying the value of the threshold while monitoring the effect on the stitched spectrum and setting a final value of the threshold judged on the stitched spectra. The selection may be performed manually, for example by an expert operator judging the stitched spectra by eye, or automatically using some test criterion.

Optionally, the method comprises performing the first Fourier transform on more than half the transient. For example, the method may comprise performing the first Fourier transform on 80% or more of the transient, or on 90% or more of the transient. The method may comprise performing the first Fourier transform on all the transient. The method may comprise performing the first Fourier transform on more than one portion of the transient, for example on two or more portions that together make up over 80% of the transient. The method may comprise performing the second Fourier transform on less than half the transient. For example, the method may comprise performing the second Fourier transform on 20% or less of the transient, or on 10% or less of the transient. The method may comprise performing the second Fourier transform on the initial part of the transient, i.e. from the start of the transient. This initial part of the transient corresponds to the data first collected and so will have the best statistics. The method may comprise performing the second Fourier transform on more than one portion of the transient, for example on two or more portions that together make up 20% or less over of the transient.

The method may comprise padding the second portion of the transient with zeros to match the length of the first portion of the transient prior to performing the first and second Fourier transforms such that the transforms generate the same number of output bins.

The size of the candidate peak in the first mass spectrum and the corresponding peak in the second mass spectrum can be measured in different ways. For example, the areas under the peaks or the amplitudes of the peaks or the widths of the peaks may be used as a measure of the peak size. The areas or amplitudes of the peaks may be measured relative to a baseline such as the noise level. A further way of measuring the peak size is to add the contents of the Fourier transform bins corresponding to each peak.

When a peak in the first mass spectrum is replaced with the corresponding peak from the second mass spectrum, the window of data replaced may be defined in different ways. For example, a window of data corresponding to where the peak meets the background signal may be chosen. Wider windows may also be chosen, for example to include a margin to either side of the peak.

The method can be applied to more than a single candidate peak within the first mass spectrum, and the methods described above may be repeated for all peaks such that multiple suppressed peaks in the first mass spectrum are replaced with the corresponding peaks from the second mass spectrum. Optionally, all peaks in the first mass spectrum may be treated as a candidate peak, and the methods described above repeated for all peaks. The largest peak need not be treated as a candidate peak, for example when the largest peak is used as the reference for normalisation. When adjacent peaks in the first mass spectrum are identified as being suppressed, a part of the mass spectrum extending between the peaks and including the peaks may be replaced with the corresponding part from the second mass spectrum.

The stitched spectrum may be used in many different ways. For example, the stitched spectrum may be displayed, or the stitched spectrum may be used to determine relative ion abundances or for proteomics post processing.

The present invention also extends to a computer program comprising computer program instructions that, when executed on one or more computer processors, cause the one or more computer processors to perform any of the methods described above, and to a computer readable medium having stored therein such a computer program. The present invention also resides in a computer apparatus comprising one or more computer processors and a computer memory having stored therein such a computer program, and in a mass spectrometer comprising one or more computer processors and a computer memory having stored therein such a computer program.

### BRIEF DESCRIPTION OF THE DRAWINGS

FIG. 1 shows mass spectra derived from transients of different lengths corresponding to resolutions ranging from 7.5k to 240k resolution;

FIG. 2 is a simplified schematic representation of the stitching process;

FIG. 3 is a schematic representation of a method of generating a stitched mass spectrum in Fourier transform mass spectrometry according to an embodiment of the present invention;

FIG. 4 illustrates an exemplary stitching process using synthetic data;

FIG. 5 illustrates an exemplary stitching process using real data; and

FIG. 6 illustrates the exemplary stitching process of FIG. 4 applied to real data.

### DETAILED DESCRIPTION

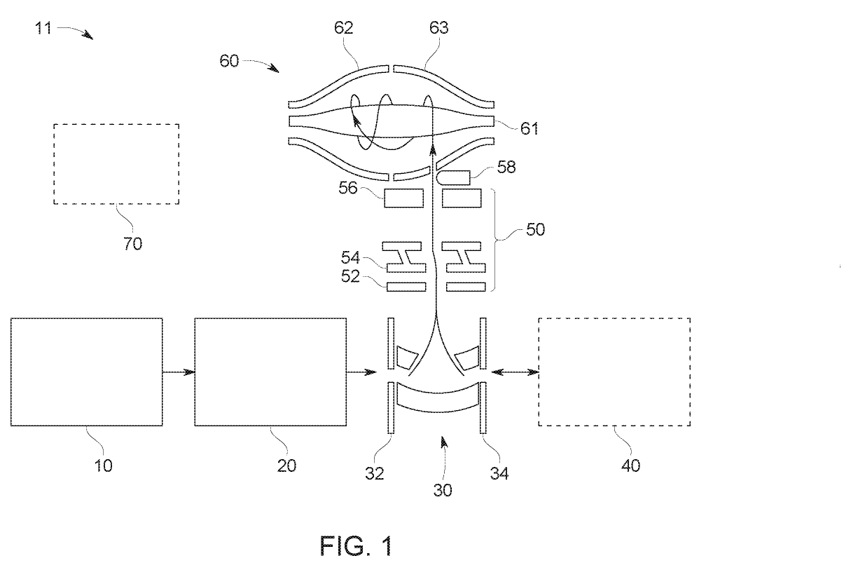

FIG. 1 illustrates schematically a mass spectrometer 11 that may be used in Fourier transform mass spectrometry. The mass spectrometer 11 includes an ion source 10, one or more ion transfer stages 20, a mass analyser 60, and an ion trap 30.

The ion source 10 is configured to generate ions from a sample. The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible. More than one ion source may be provided and used. The ions may be any suitable type of ions to be analysed, e.g. small and large organic molecules, biomolecules, DNA, RNA, proteins, peptides, fragments thereof and the like.

The ion transfer stage(s) 20 are arranged downstream of the ion source 10 and may include an atmospheric pressure interface and one or more ion guides, lenses and/or other ion optical devices configured such that some or all the ions generated by the ion source 10 can be transferred from the ion source 10 to the ion trap 30. The ion transfer stage(s) 20 may include any suitable number and configuration of ion optical devices, for example optionally including one or more RF and/or multipole ion guides, one or more ion guides for cooling ions, one or more mass selective ion guides (e.g. a mass filter such as a quadrupole mass filter), and so on.

The ion trap 30 is arranged downstream of the ion transfer stage(s) 20 and is configured to receive and accumulate ions from the ion source 10 (via the one or more ion transfer stages 20). The ion trap 30 can comprise any suitable ion trap, such as a quadrupole ion trap. The ion trap 30 may be elongated in an axial direction (thereby defining a trap axis) in which the ions enter the trap. Ions may be trapped radially in the trap 30 by applying RF voltage(s) to trapping (e.g. rod) electrodes of the trap. As shown in FIG. 1, the ion trap 30 may be a curved linear ion trap (C-trap), i.e. where the trapping rod electrodes are curved. However, the ion trap 30 may be any other suitable type of ion trap, such as for example a linear ion trap.

The ion trap 30 includes an entrance lens or gate 32 and an exit lens or gate 34. Ions from the ion source 10 can be accumulated in the ion trap 30 by operating the exit lens 34 in its closed mode, while operating the entrance lens 32 in its open mode. After a desired ion fill time of ions into the ion trap 30, the entrance lens 32 can be closed (by altering the voltage applied to the entrance lens 32) such that ions cannot pass out of the trap 30 and such that ions from the ion source 10 can no longer enter the ion trap 30. In some embodiments, more accurate gating of the incoming ion beam into the trap 30 can be provided by a lens or gate electrode within the ion transfer stage(s) 20 upstream of the ion trap 30. In these arrangements, the lens or gate electrodes may be configured such that the transmission of ions into the ion trap 30 can be switched on or off.

Thus, the mass spectrometer 11 is configured such that ions can be accumulated in the ion trap 30 with an adjustable accumulation time (fill time). By controlling the fill time of ions into the ion trap 30, where the flux of ions into the ion trap 30 is known or can be approximated, the total number of ions accumulated in the ion trap 30 can be controlled.

As illustrated by FIG. 1, once accumulated in the ion trap 30, ions within the trap 30 can be ejected into the mass analyser 60. The ions may be ejected from the trap 30 in a direction orthogonal to the axis of the ion trap 30 (orthogonal ejection), for example by applying one or more suitable DC voltages to the ion trap 30.

The ions may be injected into the mass analyser 60 via one or more lenses 50 such as a Z-lens 54, and a deflector electrode 58. As shown in FIG. 1, the one or more lenses 50 may include a so-called V-lens 52, followed by a Z-lens 54, followed by a high voltage (HV) focus lens 56.

The mass analyser 60 is arranged downstream of the ion trap 30 and is configured to receive and accumulate ions from the ion trap 30 (via the one or more lenses 50 and the deflector electrode 58). In the embodiment depicted in FIG. 1, the mass analyser 60 is an electrostatic orbital trap, and more specifically an Orbitrap(TM) FT mass analyser as made by Thermo Fisher Scientific(TM).

As shown in FIG. 1, the orbital trap mass analyser 60 comprises an inner electrode 61 elongated along the orbital trap axis and a split pair of outer electrodes 62, 63 which surround the inner electrode 61 and define therebetween a trapping volume. Ions trapped in the trapping volume orbit around the inner electrode 61 to which is applied a trapping voltage whilst oscillating back and forth along the axis of the trap. The pair of outer electrodes 62, 63 function as detection electrodes to detect an image current induced by the oscillation of the ions in the trapping volume and thereby provide a detected signal (“transient”).

The outer electrodes 62, 63 typically function as a differential pair of detection electrodes and are coupled to respective inputs of a differential amplifier (not shown in FIG. 1), which in turn forms part of a digital data acquisition system to receive the detected signal (transient). The detected signal (transient) can be processed using Fourier transformation to obtain a mass spectrum of ions within the ion trap 30 that are ejected into the mass analyser 60.

The mass spectrometer 11 may include a collision or reaction cell 40, e.g. downstream (or upstream) of the ion trap 30. Where the collision or reaction cell 40 is present, ions collected in the ion trap 30 can either be ejected orthogonally to the mass analyser 60 without entering the collision or reaction cell 40. Alternatively, ions can be transmitted axially to the collision or reaction cell 40 for processing before returning the processed ions to the ion trap 30 for subsequent orthogonal ejection to the mass analyser 60. The processing may comprise, for example, fragmenting the ions by collisions with a collision gas and/or a reagent in the collision cell 40, or further cooling the ions by collisions with a gas at a lower energy that does not fragment the ions.

As also shown in FIG. 1, the mass spectrometer 11 is under the control of a control unit 70, such as an appropriately programmed computer, which controls the operation of various components of the mass spectrometer 11 and, for example, sets the voltages to be applied to the various components of the mass spectrometer 11. The control unit 70 may also receive and process data from various components including the mass analyser 60, e.g. perform Fourier transformation on detected signals (transients).

The mass spectrometer 11 may be operated such that successive batches of ions from the ion source 10 are each analysed by the mass analyser 60. Each batch of ions is firstly accumulated in the ion trap 30, and then the accumulated ions (or e.g. fragment ions derived from the accumulated ions) are injected into the mass analyser 60. A respective detected signal (transient) is produced in respect of each batch of ions, and a respective mass spectrum may be produced from each detected signal (transient) using Fourier transforms.

The mass spectrometer 11 may be operable in various mode of operation. In particular, the mass spectrometer may be a tandem mass spectrometer 11 operable in an MS1 mode of operation and an MS2 mode of operation.

In the MS1 (or “full mass scan”) mode of operation, a mass filter (not shown) of the ion transfer stages 20 is operated in a transmission mode of operation and the fragmentation device 40 is operated in a non-fragmentation mode of operation or is not utilised, e.g. so that a wide m/z range (e.g. full mass range) of unfragmented (“precursor” or “parent”) ions are analysed by the mass analyser 60 to produce an MS1 spectrum.

In the MS2 mode of operation, the mass filter is operated in a filtering mode of operation and the fragmentation device 40 is operated in its fragmentation mode of operation, e.g. so that a selected narrow m/z range of precursor ions are fragmented, and the resulting fragment (“product” or “daughter”) ions are analysed by the mass analyser 60 to produce an MS2 spectrum.

The mass spectrometer 11 may also be operable in one or more higher order fragmentation modes of operation, such as for example an MS3 mode of operation, whereby precursor ions are fragmented, at least some of the resulting fragment ions are themselves fragmented, and the second-generation fragment ions (“granddaughter ions”) are analysed by the mass analyser 60 produce an MS3 spectrum.

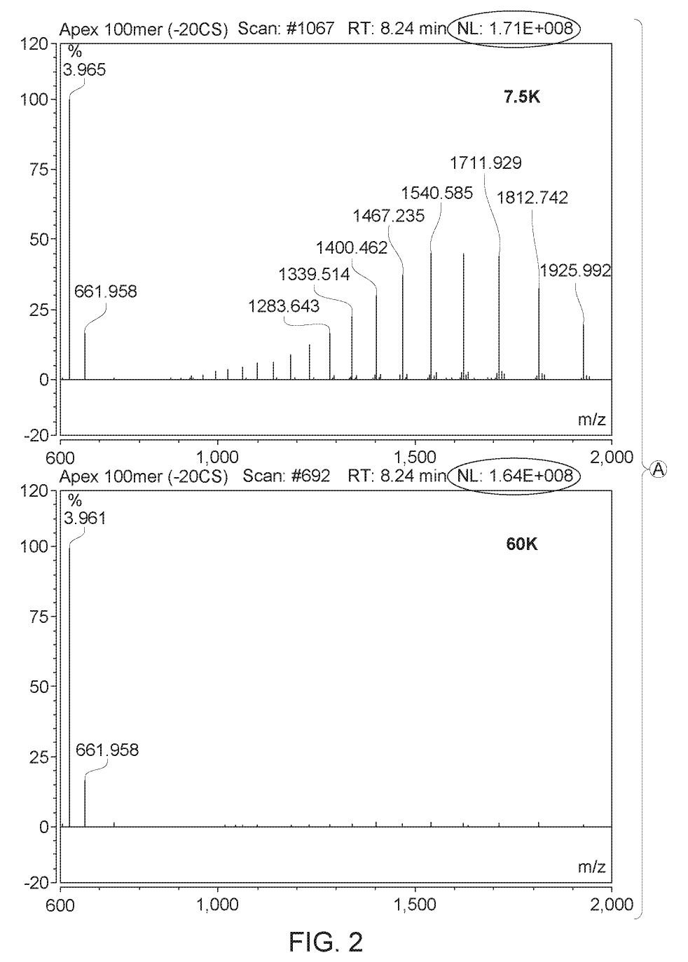

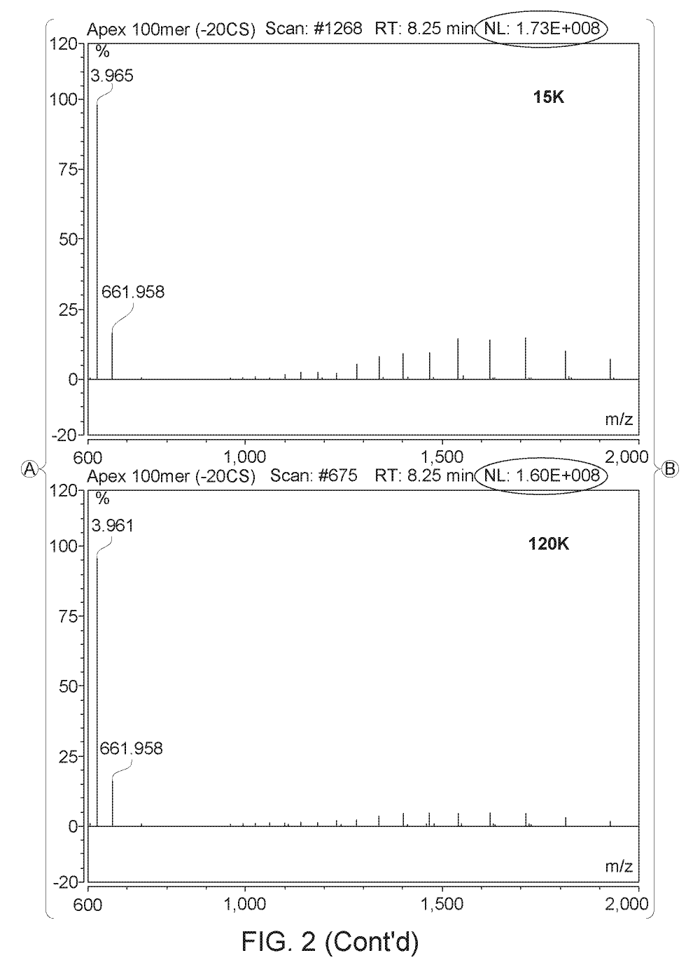

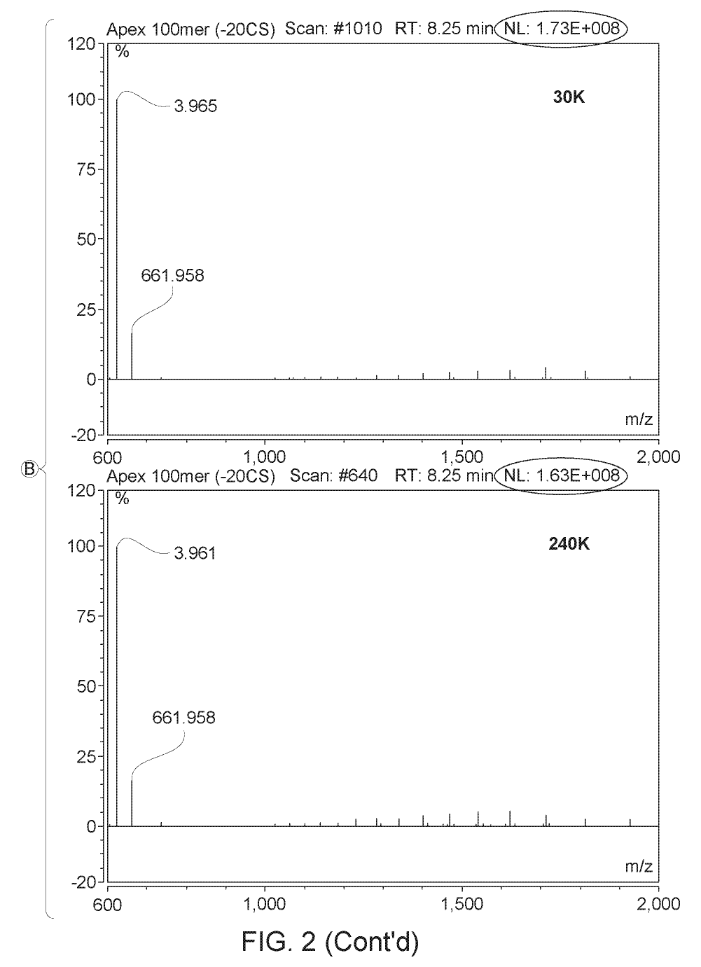

As explained above, destructive interference between peaks in a mass spectrum can arise when two ions produce spectral peaks that are very close together to the point where they cannot be fully resolved by the Fourier transformation. This interference leads to diminished signals and an underreporting of the abundance of those two ions. An example of this is displayed in FIG. 2. The amplitudes of the peaks arising from m/z between 1200 and 2000 decrease from 7.5k to 60k resolution as the peaks are not fully resolved at these resolutions. The peak amplitudes then increase from 60k to 240k resolution once the peaks are fully resolved. Previously, removing the detrimental influence of the interference necessitated several measurements of transients at different resolutions and the manual combination of the resulting mass spectra. In the example of FIG. 1, the lower mass range (< ~700 m/z) could be measured at the highest resolution available, and the higher mass range (> ~700 m/z) could be measured with the lowest resolution available.

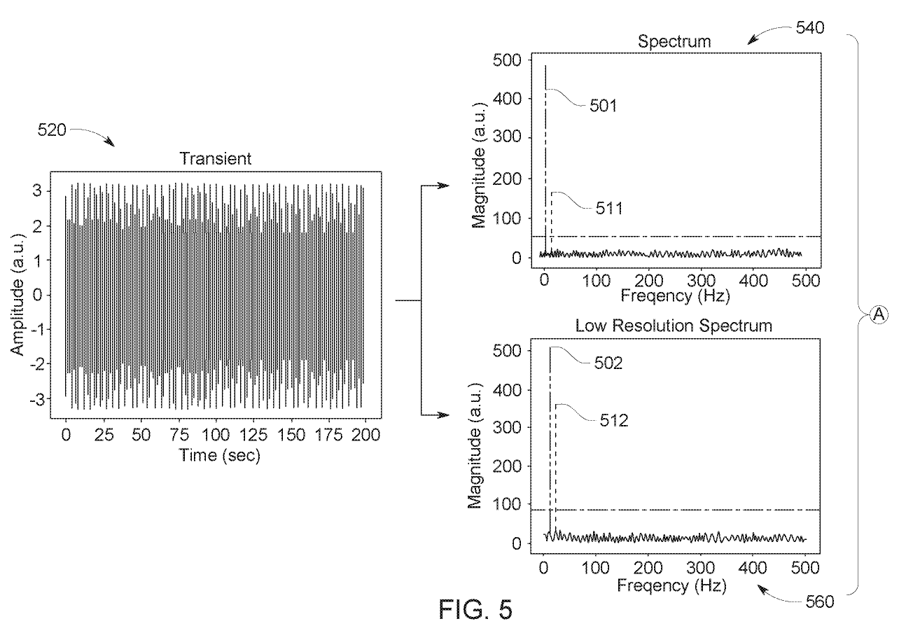

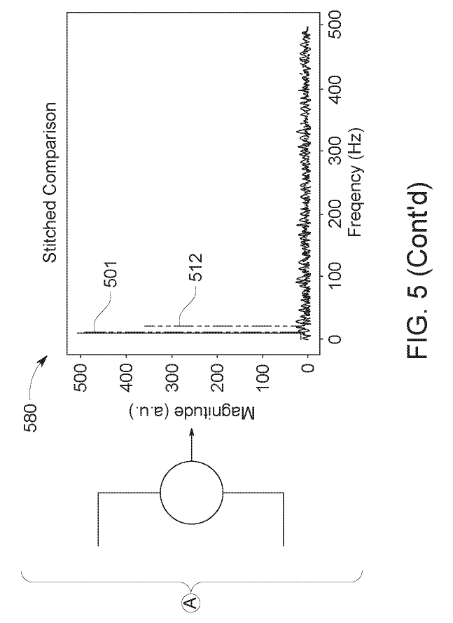

The interference between the closely-spaced ions leads to a distinguished “beat” pattern in time domain which can be seen in the transient of FIG. 5 (see leftmost part of that figure), where the absolute intensity depends on the relative position of the transient’s end relative to the beat structure. This is then seen as the interference in the mass spectrum that suppresses certain peak intensities.

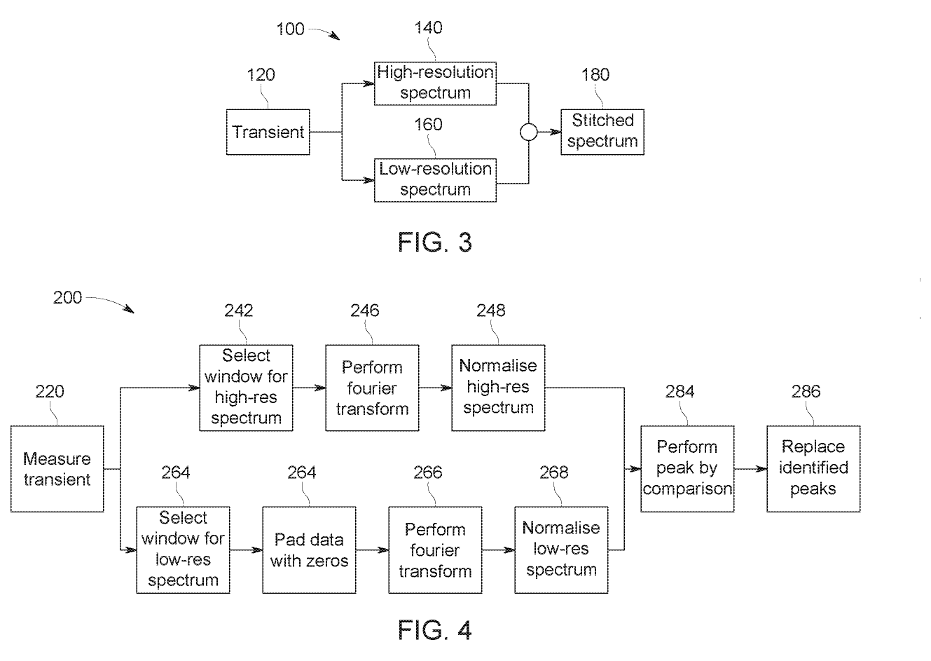

To address the problem of interference leading to peak suppression, a method 100 of processing transient data was developed that avoids additional scans and additional usage of sample. FIG. 3 shows this method 100. A transient is acquired at step 120 at a certain resolution. Typically, this resolution will be a high resolution, i.e. over a relatively long scan time. An example of such a transient 520 is shown in FIG. 5. For example, a high resolution of 480000 may be used (and a low resolution may correspond to 7500).

This transient 520 is then analysed at two different resolutions, one relatively high and one relatively low. For example, most or all the transient 500 may be used as the input to a Fourier transform at step 140 to produce a high-resolution spectrum 540 like that shown in FIG. 5. Only a part of the transient 520 may be used as the input to a Fourier transform at step 160 to produce a low-resolution spectrum 560 like that shown in FIG. 5. Less than half of the transient 520 may be used to generate the low-resolution spectrum 560, and the portion may be taken from the start of the transient 520 (i.e. the data first collected during the scan).

Each mass spectrum 540 and 560 comprises a set of peaks each having an associated intensity. At step 180, each peak in the high-resolution spectrum 540 is evaluated and any peaks having an intensity less than expected are replaced by the corresponding peaks from the low-resolution spectrum 560, thereby producing a stitched mass spectrum 580 like that shown in FIG. 5. In practice, the low-resolution peaks may be inserted into the graphical representation of the mass spectrum, or the underlying Fourier transform data may be replaced (e.g. the data in the Fourier transform bins corresponding to the diminished peaks may be replaced with data taken from the low-resolution spectrum 560). The latter option will of course also produce the graphical representation of the stitched mass spectrum 580.

There are different ways of determining that a peak in the high-resolution spectrum 540 is suppressed. For example, an absolute threshold could be used throughout the entire high-resolution spectrum 540 such that every peak with a size less than the threshold is replaced by the corresponding peak from the low-resolution spectrum 560. Another option is to use a variable threshold that varies with m/z value. For example, the variable threshold may decrease as the m/z value of the peak in the high-resolution spectrum 540 increases.

Rather than considering just the peaks in the high-resolution spectrum 540, peaks in both the high-resolution spectrum 540 and the low-resolution spectrum 560 can be used. A currently preferred option is to use the intensities of the peaks in the low-resolution spectrum 560 as a reference level against which the corresponding peaks in the high-resolution spectrum 540 can be gauged. In this way, the threshold becomes a relative threshold. The relative threshold may be a constant relative threshold, e.g. any peak in the high-resolution spectrum 540 found to have a size less than a given fraction of the corresponding peak in the low-resolution spectrum 560 is replaced when forming the stitched spectrum 580. The relative threshold may be set manually or automatically, and may be set iteratively (e.g. such that the stitched spectrum 580 arising from different thresholds are compared and scored, and the higher-scored stitched spectra used to improve the variable threshold iteratively). Alternatively, a variable relative threshold may be used.

A method 200 corresponding to a more detailed example will now be described with reference to FIG. 4. At step 220, a transient 520 is measured using a mass spectrometer, for example a mass spectrometer 11 like that of FIG. 1. The transient 520 may be recorded over one or more fills of the mass analyser 60. The transient 520 is recorded over a relatively long time to provide a high resolution of 480k.

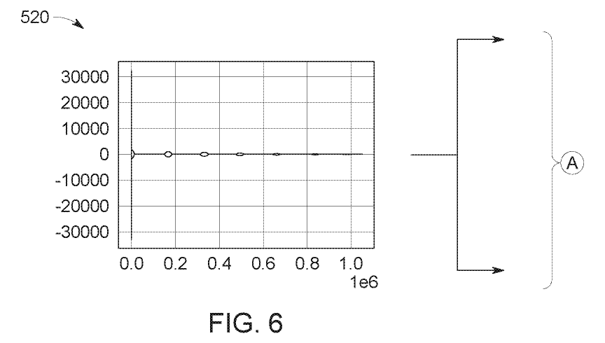

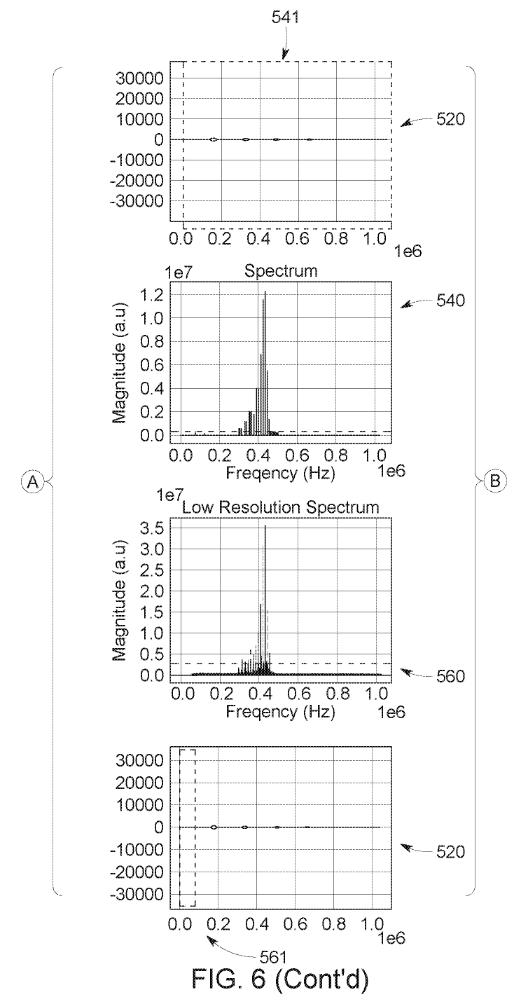

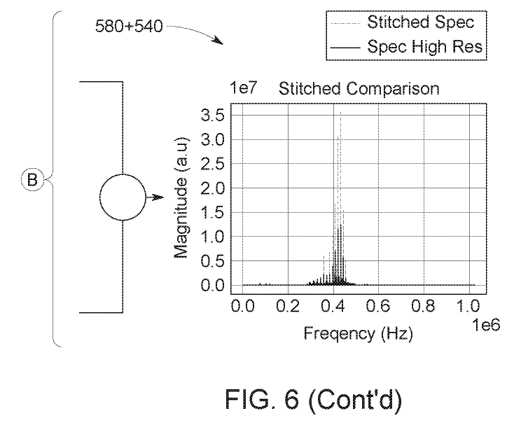

To obtain a high-resolution spectrum 540, a window of the transient data is selected at step 242. An example of such a window 541 is shown in FIG. 6. This window of data 541 is subjected to a Fourier transform at step 246. In this embodiment, the full set of transient data is used, i.e. the window 541 extends over the entire scan length.

To get a low-resolution spectrum 560, at step 264, the 480k transient data are cut to correspond to a low-resolution transient with a resolution of 7.5k. This is achieved by keeping the length of transient data from a window corresponding to the initial period of the scan that produces a resolution of 7.5k. The remainder of the transient 520 is discarded. An example of such a window 561 is shown in FIG. 65. At step 264, the cut transient data are padded with zeros to ensure the discrete Fourier transform bins have the same number in both the high-resolution mass spectrum 540 and the low-resolution spectrum 560. At step 266, the low-resolution transient data are subjected to a Fourier transform to generate the low-resolution spectrum 560.

To determine the presence of suppressed peaks in the high-resolution spectrum 540, a peak-by-peak comparison of the low-resolution and high-resolution spectra 540 and 560 is performed. This comparison establishes whether each peak in the high-resolution spectrum 540 exceeds a fixed relative threshold. However, to make the comparison reliable, the high-resolution and low-resolution spectra 540 and 560 are normalised at steps 248 and 268 respectively. The intensities in the Fourier transform bins for each spectrum 540 and 560 are scaled relative to the largest peak in the high-resolution spectrum 540.

Then, at step 284, the presence of suppression by interference is determined by comparing the size of corresponding peaks in the high-resolution spectrum 540 and the low-resolution spectrum 560, i.e. peaks at the same or substantially the same m/z values. The size of the peaks may be the amplitude, width or area of the peaks. The amplitude, width or area may be measured relative to a baseline, e.g. the noise level. In this embodiment, suppressed peaks are identified as those peaks in the high-resolution spectrum 540 for which the intensity sum of all bins belonging to that peak is at least 6 times lower than for the corresponding bins in the low-resolution spectrum 560. Hence, step 184 produces a list of identified peaks that do not exceed this constant relative threshold of 1/6.

At step 286, the stitched spectrum 580 is produced by replacing each identified peak in the high-resolution spectrum 540 with the corresponding portion of the low-resolution spectrum 560. This may be done by replacing the bin intensity values in the high-resolution spectrum 540 with the corresponding bin intensity values from the low-resolution spectrum 560.

The results obtained by applying the method 200 of FIG. 4 to synthetically generated data is shown in FIG. 5. The left part of FIG. 5 shows the synthetically generated transient 52, which displays the characteristic beat pattern, namely the low frequency variation that goes through around five cycles in the figure. The middle part of FIG. 5 shows both the normalised high-resolution spectrum 540 and the normalised low-resolution spectrum 560. Peak 501 is the most intense peak in the high-resolution spectrum 540, and so the peaks in each spectrum 540 and 560 are normalised to peak 501. Corresponding peaks 511 and 512 also appear in the high-resolution and low-resolution spectra 540 and 560. It is immediately evident that the peak 511 in the high-resolution spectrum 540 is suppressed relative to the corresponding peak 512 in the low-resolution spectrum 560. Hence, when forming the stitched spectrum 580 from the high-resolution spectrum 540, peak 511 is replaced by peak 512 from the low-resolution spectrum 560.

FIG. 6 shows the method 200 of FIG. 4 applied to real data. Namely, a transient 520 was collected from Oligomer samples. The transient 520 was processed to produce a normalised high-resolution spectrum 540 and a normalised low-resolution spectrum 560. FIG. 6 also shows the window of data used to generate the high-resolution and low-resolution spectra 540 and 560. The upper part of FIG. 6 shows that a window 541 corresponding to the entire transient 520 was used to generate the high-resolution spectrum 540. The lower part of FIG. 6 shows that the window 561 used to generate the low-resolution spectrum 560 encompasses just an initial fraction of the transient 520. The final part of FIG. 6 shows both the stitched spectrum 580 and the high-resolution spectrum 540 shown together.

It will be understood by those skilled in the art that the invention is not limited to the embodiments shown and that many additions and modification may be made without departing from the scope of the invention as defined in the appending claims.

The methods 100 and 200 described above an analysis of one or two mass spectra to determine peaks in the high-resolution spectrum 540 that are to be replaced with peaks from the low-resolution spectrum 560 when forming the stitched spectrum 580. Alternatively, three or more mass spectra could be used in a comparison that determines which peaks to replace. This would enable to quantification of each m/z at its optimal resolution.

Rather than just replacing a peak identified as being suppressed in the high-resolution spectrum 540, a larger m/z range around the peak could be replaced with the corresponding part of the low-resolution spectrum 560. Consequently, an adjustable m/z range around a suppressed is replaced by low-resolution peaks. This results in fewer, larger connected portions of the low-resolution spectrum 560 appearing in the stitched spectrum 580.

The stitching processes described above are based on a simple thresholding of peak sizes. Another way would be to identify m/z ranges/peaks in the high-resolution spectrum 540 that should be replaced is to base the selection on the m/z values present in the high-resolution spectrum 540 and not only the intensity. One could either prespecify certain m/z ranges in which interference is expected to dominate, or those ranges could be automatically identified from a list of analytes. This automatic identification can be achieved by converting m/z values into frequencies and calculating how those frequencies would interfere with each other. Another option is to use a user specified stitching range if the results from automatic stitching are not satisfactory.

The embodiments describe performing Fourier transforms on single portions of the transient (all the transient in the case of forming the high-resolution mass spectrum 540). However, this need not be the case and Fourier transforms may be made of two or more portions of the transient.

The process of selecting the stitching area as well as the resolutions could be supplemented using AI or genetic algorithms. A machine learning model could be trained on selecting optimal resolutions and synthesizing a spectrum from those resolutions with respect to signal quality. Genetic algorithms could be used to optimise the parameters of the stitching algorithm such as the threshold for selecting the peaks, the resolutions used as well as other parameters depending on the specific implementation.

1. A method of generating a stitched mass spectrum in Fourier transform mass spectrometry, the method comprising:
obtaining a transient recorded from ions stored within a mass spectrometer;
performing a first Fourier transform of at least a first portion of the transient at a first resolution to obtain a first mass spectrum;
performing a second Fourier transform of at least a second portion of the transient at a second resolution to obtain a second mass spectrum, wherein the second resolution is lower than the first resolution;
comparing a peak size of a candidate peak in the first mass spectrum against a threshold;
responsive to determining that the peak size of the candidate peak of the first mass spectrum is less than the threshold, replacing the candidate peak in the first mass spectrum with the corresponding peak in the second mass spectrum, thereby producing a stitched mass spectrum.

2. The method of claim 1, further comprising normalizing the first mass spectrum prior to comparing the peak size of the candidate peak in the first mass spectrum against the threshold.

3. The method of claim 2, further comprising:
normalizing the second mass spectrum prior to comparing the peak size of the candidate peak in the first mass spectrum against the threshold; and
determining the peak size of the candidate peak in the first mass spectrum relative to the corresponding peak size of the corresponding peak in the second mass spectrum to obtain a relative peak size of the candidate peak in the first mass spectrum; and
wherein comparing the peak size of the candidate peak in the first mass spectrum against the threshold comprises comparing the relative peak size to the threshold.

4. The method of claim 1, wherein the threshold has a constant value applied for all m/z values in the first mass spectrum.

5. The method of claim 1, wherein the threshold varies as a function of the m/z values in the first mass spectrum, optionally such that the threshold decreases in value as the m/z values increase.

6. The method of claim 1, comprising setting the value of the threshold manually or automatically.

7. The method of claim 6, comprising varying the value of the threshold while monitoring the effect on the stitched spectrum, and setting a final value of the threshold judged on the stitched spectra.

8. The method of claim 1, wherein performing the first Fourier transform of the at least a first portion of the transient comprises performing the first Fourier transform on more than half the transient.

9. The method of claim 8, wherein performing the first Fourier transform of the at least a first portion of the transient comprises performing the first Fourier transform on all the transient.

10. The method of claim 1, wherein performing the second Fourier transform of the at least a second portion of the transient comprises performing the second Fourier transform on less than half the transient.

11. The method of claim 10, wherein performing the second Fourier transform of the at least a second portion of the transient comprises performing the second Fourier transform on the initial part of the transient.

12. The method of claim 1, wherein performing the first and second Fourier transforms of the at least a first portion and at least a second portion of the transient comprises performing the first and second Fourier transforms on the same length of transient thereby to generate the same number of output bins.

13. The method of claim 12, further comprising padding the at least a second portion of the transient with zeros to match the length of the at least a first portion of the transient.

14. The method of claim 1, wherein the peak size is a peak amplitude or a peak area.

15. The method of claim 1, further comprising displaying the stitched spectrum.

16. The method of claim 1, further comprising determining relative ion abundances from the stitched mass spectrum.

17. A computer program comprising computer program instructions that, when executed on one or more computer processors, cause the one or more computer processors to perform the method of claim 1.

18. A computer readable medium having stored therein a computer program in accordance with claim 17.

19. A computer apparatus comprising one or more computer processors and a computer memory having stored therein a computer program in accordance with claim 17.

20. A mass spectrometer comprising one or more computer processors and a computer memory having stored therein a computer program in accordance with claim 17.
